(19) United States
(12) Patent Application Publication
(10) Pub. No.: US 2019/0148927 A1
(43) Pub. Date: May 16, 2019

(54) ELECTRIC WIRE ARRANGEMENT STRUCTURE AND CIRCUIT BODY FOR VEHICLE

(71) Applicant: Yazaki Corporation, Tokyo (JP)

(72) Inventors: Shingo KATO, Susono-shi (JP); Masataka NISHIJIMA, Susono-shi (JP)

(73) Assignee: Yazaki Corporation, Tokyo (JP)

(21) Appl. No.: 16/182,968

(22) Filed: Nov. 7, 2018

(30) Foreign Application Priority Data
Nov. 13, 2017 (JP) 2017-218441

(51) Int. Cl. H02G 3/38; H02G 3/04; B60R 16/023

(52) U.S. Cl. CPC H02G 3/383; H01B 7/0846; B60R 16/0238; H02G 3/0406

(57) ABSTRACT

An electric wire arrangement structure includes an accommodation recessed part disposed in an inner surface of a compartment of a body panel, an electric wire which is at least partly accommodated in the accommodation recessed part, and a holding member which accommodates and holds at least a part of the electric wire in the accommodation recessed part.

### CROSS REFERENCE TO RELATED APPLICATIONS

This application claims priority from Japanese Patent Application No. 2017-218441 filed on Nov. 13, 2017, the entire contents of which are incorporated herein by reference.

### BACKGROUND OF THE INVENTION

### Field of the Invention

The present invention relates to an electric wire arrangement structure and a circuit body for a vehicle.

### Description of Related Art

An electric power distribution system is known (for in stance, see patent document 1: JP-A-9-275632) which is applied to a vehicle or the like to distribute and supply an electric power to various kinds of electrical equipment loads. A vehicle body is divided into, for instance, an engine room and a compartment such as a riding room arranged in a rear part of the engine room or a trunk room. In the engine room, a power source part such as a battery or an alternator which supplies an electric power of a determined voltage, an electric connection box such as a joint box which is connected to the power source part to distribute the electric power and various kinds of electric equipment loads such as a head lamp are arranged. Further, in the compartment, an electric connection box which is connected to the joint box to further distribute the supplied electric power to various kinds of loads and various kinds of electrical equipment loads such as an illumination of meters or various kinds of switches are provided. These electric connection boxes are connected together through a main line and further connected to the various kinds of electrical equipment loads through branch lines. An electric wire arrangement structure formed with the main line or the branch lines is ordinarily and usually arranged in a compartment side of a vehicle body panel.

Further, for instance, in a rear battery vehicle, a long battery cable (an electric wire) is required which supplies an electric power from a front part to a rear part. As the battery cable, a round shaped or a flat shaped thick electric wire for a motor vehicle is ordinarily used. Such a battery cable is also ordinarily arranged in the compartment side of the vehicle body panel.
[Patent Document 1] JP-A-9-275632

According to a related art, in an electric wire arrangement structure, when the electric wires by a main line or branch lines form multiple circuits, an arrangement space is large which protrudes to an inside of a compartment. Thus, a residence space in the compartment is oppressed. Especially, when the electric wire is a main line (what is called a thick electric wire) whose outside diameter is large, the residence space in the compartment is outstandingly oppressed. Further, in the electric wire arrangement structure, when the electric wire is arranged at one's feet, since the electric wire protrudes from a floor panel (an underbody), a load stress due to a stepping is concentrated on the electric wire. Thus, there is a fear that the electric wire may be cut. Further, when the battery cable of the rear battery vehicle is arranged in the compartment, the same problem arises.

### SUMMARY

One or more embodiments provide an electric wire arrangement structure and a circuit body for a vehicle which can restrain a space in a compartment from being oppressed by an electric wire and the electric wire from being cut at the same time.

The above-described object of the present invention is achieved by below-described structures.
(1) An electric wire arrangement structure includes an accommodation recessed part disposed in an inner surface of a compartment of a body panel, an electric wire which is at least partly accommodated in the accommodation recessed part, and a holding member which accommodates and holds at least a part of the electric wire in the accommodation recessed part.

According to the electric wire arrangement structure having the structure of above-described (1), an accommodation recessed part is formed in an inner surface of a compartment of a body panel. In the accommodation recessed part, at least one part of an electric wire is accommodated. The electric wire is held in the accommodation recessed part by a holding member. The electric wire accommodated in the accommodation recessed part does not protrude outside the recessed part from an opening of the recessed part. Accordingly, an oppression of a residence space in the compartment due to a protrusion of the electric wire to the compartment side from the inner surface of the compartment does not occur. When the body panel is, for instance, a floor panel of a riding room, a load stress due to a stepping is supported by edges of the recessed part at both sides which hold a width of the recessed part, so that the load stress is hardly concentrated on the electric wire. Accordingly, the electric wire can be avoided from being cut.
(2) The electric wire arrangement structure according to the above-described (1), the holding member is a cross plate which is constructed to intersect a longitudinal direction of the accommodation recessed part.

According to the electric wire arrangement structure having the structure of the above-described (2), the electric wire can be held at a desired position in the accommodation recessed part by an easy attachment work through a cross plate using an inexpensive member.
(3) The electric wire arrangement structure according to the above-described (1), the holding member is an adhesive layer disposed between the accommodation recessed part and the electric wire.

According to the electric wire arrangement structure having the structure of the above-described (3), a long electric wire can be fixed to the accommodation recessed part in a longitudinal direction (continuously) of the accommodation recessed part and over a wide range of the accommodation recessed part.
(4) The electric wire arrangement structure according to the above-described (1) or (2), the electric wire is accommodated in the accommodation recessed part in a state that an impact absorbing member is disposed between the electric wire and the accommodation recessed part.

According to the electric wire arrangement structure having the structure of the above-described (4), to the electric wire accommodated in the accommodation recessed part, an impact directly applied to the electric wire from the opening of the recessed part, a stress due to the deformation of the body panel or an impact applied through the body panel from an outer surface of the compartment can be absorbed by an impact absorbing member. Further, since the impact absorbing member occupies a space between the accommodation recessed part and the electric wire, a backlash of the electric wire or an abrasion due to a vibration can be suppressed.
(5) The electric wire arrangement structure according to any one of the above-described (1) to (4), the accommodation recessed part is disposed in a shoulder part of the center tunnel in the body panel.

According to the electric wire arrangement structure having the structure of the above-described (5), at least one part of the electric wire is accommodated in the accommodation recessed part formed in a shoulder part of a center tunnel which continuously rises in the inner surface of the compartment of the body panel. In the center tunnel, a section intersecting at right angles to a longitudinal direction has a rectangular form and rises. The accommodation recessed part is formed along an extending direction of the center tunnel by such a way that either of the rectangular right and left shoulder parts is cut out in the shape of L in section. According to the electric wire arrangement structure, the electric wire can be arranged without oppressing a residence space in the compartment not only in the planar inner surface of the compartment, but also in the rising part (the protruding part) in the inner surface of the compartment.
(6) A circuit body for a vehicle includes a main line having a power supply line with a determined current capacity and arranged in a vehicle body, a branch line connected to an electrical equipment load, and a control box which has a control part distributing an electric power which is supplied from the power supply line to the main line, to the branch line connected to the main line, and which is arranged on the main line. At least one of the main line and the branch line is formed with an electric wire which is at least partly accommodated in an accommodation recessed part disposed in an inner surface of a compartment of a body panel. At least a part of the electric wire is accommodated and held in the accommodation recessed part by a holding member.

According to the circuit body for a vehicle having the structure of the above-described (6), the whole part of the circuit body is used as a transmission path which is required to supply an electric power of a main power source such as a battery respectively to various kinds of electrical equipment loads of parts of a vehicle body and transmit and receive signals between the electrical equipment loads. The circuit body for the vehicle can form a circuit of a simple structure with a main line having a determined current capacity and a determined communication capacity and arranged in the vehicle body and branch lines which connect the various kinds of electrical equipment loads to the main line through a control box dispersed and arranged along the main line. Then, at least one of the electric wires forming the main line and the branch lines of the circuit body for the vehicle is accommodated in the accommodation recessed part formed in the inner surface of the compartment of the body panel and accommodated and held in the accommodation recessed part by the holding member. Thus, in the circuit body for the vehicle, an oppression of a residence space in the compartment due to a protrusion of the electric wire to the compartment side from the inner surface of the compartment does not occur. Further, as the various kinds of electrical equipment loads are installed, the circuit body for the vehicle needs to be arranged throughout a wide range of the inner surface of the compartment. In the circuit body for the vehicle, since at least one part of the main line or the branch lines arranged over the wide range is accommodated in the accommodation recessed part, the oppression to the residence space in the compartment can be more extremely suppressed than that in the usual structure in which the electric wire protrudes to the compartment side.
(7) The circuit body for the vehicle according to the above-described (6), the electric wire is formed with an arrangement material having at least one kind of conductors of a flat shaped conductor, a round rod conductor, and a twisted wire.

According to the circuit body for a vehicle having the structure of the above-described (7), an electric wire formed with an arrangement material having a conductor suitable for an arrangement path of the vehicle can be used for each main line between the plural control boxes. Thus, an arrangement property is improved.

According to one or more embodiments, an oppression of a residence space in a compartment by an electric wire and damage of the electric wire can be prevented at the same time.

According to one or more embodiments, an electric wire can be accommodated in an inner surface of a compartment under a protected state without oppressing a residence space in the compartment.

The present invention is briefly explained as described above. Further, when modes for carrying out the present invention which will be described below are read by referring to the attached drawings, the present invention will be more clarified.

### BRIEF DESCRIPTION OF THE DRAWINGS

FIG. 1 is a perspective view showing an arrangement example of an electric wire in a vehicle which has an electric wire arrangement structure according to a first exemplary embodiment.

FIG. 2 is an exploded perspective view of main parts of the electric wire arrangement structure shown in FIG. 1.

FIG. 3 is an enlarged sectional and perspective view of main parts which explains the electric wire arrangement structure shown in FIG. 1.

FIG. 4 is an enlarged sectional and perspective view of main parts that explains a holding member which accommodates and holds the electric wire shown in FIG. 3 in an accommodation recessed part.

FIG. 5A is an enlarged sectional view of main parts that explains an electric wire arrangement structure according to a modified example in which an adhesive layer is provided between an accommodation recessed part and an electric wire. FIG. 5B is an enlarged sectional view of main parts that explains an electric wire arrangement structure according to a modified example in which an electric wire is accommodated in an accommodation recessed part through an impact absorbing member.

FIG. 6 is a perspective view showing an arrangement example in a vehicle having an electric wire arrangement structure according to a reference example.

FIG. 7 is an enlarged sectional and perspective view of main parts that explains the electric wire arrangement structure shown in FIG. 6.

FIG. 8 is an enlarged sectional and perspective view of main parts showing an arrangement example in a vehicle which has an electric wire arrangement structure according to a second exemplary embodiment.

FIG. 9 is an enlarged sectional view of main parts which explains an electric wire arrangement structure according to a third exemplary embodiment.

FIG. 10 is a perspective view showing an arrangement example of a circuit body for a vehicle in the vehicle having an electric wire arrangement structure according to a fourth exemplary embodiment.

FIG. 11 is an enlarged sectional and perspective view of main parts which explains an electric wire arrangement structure according to a fifth exemplary embodiment.

### DETAILED DESCRIPTION

Now, exemplary embodiments will be described below by referring to the drawings.

### First Exemplary Embodiment

Initially, an electric wire arrangement structure according to a first exemplary embodiment of the present invention will be described below.

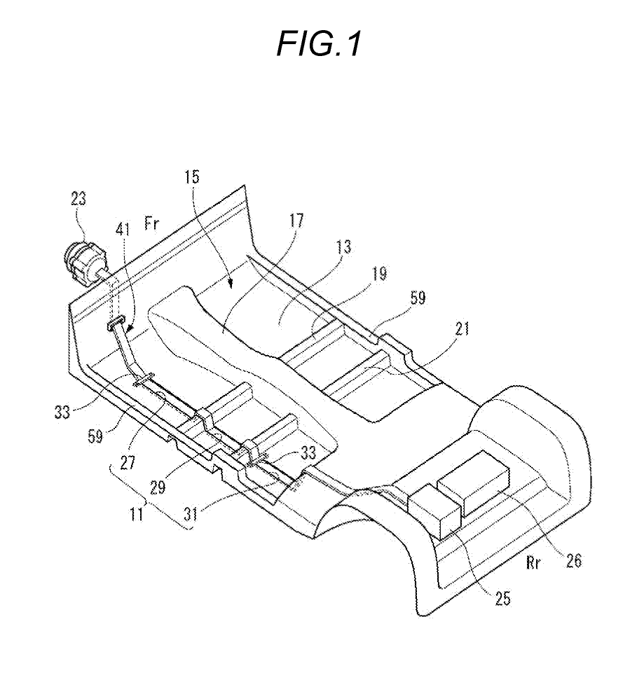

FIG. 1 is a perspective view showing an arrangement example of an electric wire in a vehicle which has an electric wire arrangement structure according to a first exemplary embodiment of the present invention.

The electric wire arrangement structure according to the first exemplary embodiment has an accommodation groove 11 which accommodates an electric wire and a cross plate 33 as a holding member as main components.

The accommodation groove 11 is provided in an inner surface 13 of a compartment of a body panel. The accommodation groove 11 is recessed as an accommodation recessed part exclusively used for arranging the electric wire and the size of the groove is designed so as to meet the size of the electric wire or the number of circuits.

In the first exemplary embodiment, the body panel is a floor panel 15 (an underbody). The body panel is not limited to the floor panel 15. In the center of the floor panel 15 in a direction of width of a vehicle, a center tunnel 17 extending forward and rearward of the vehicle is formed to protrude to the inner surface 13 of the compartment. In addition thereto, in the front panel 15, a front cross member 19 or a rear cross member 21 which extends in the direction of width of the vehicle and intersects the enter tunnel 17 is formed to protrude in the inner surface 13 of the compartment. In a front (Fr) side of the floor panel 15, an alternator 23 or the like is arranged. In a rear (Rr) side of the floor panel 15, a rear battery 25 or a fuse box 26 is arranged.

In such a rear battery vehicle, a battery cable is necessary as the electric wire which supplies an electric power from a rear part to a front part. In the electric wire arrangement structure according to the first exemplary embodiment, this electric wire is accommodated in the accommodation groove 11. The accommodation groove 11 is formed in the floor panel 15 so as to extend, for instance, forward and rearward of the vehicle. The position and the extending direction of the accommodation groove 11 are not limited to those described above. The accommodation groove 11 is formed in the inner surface 13 of the compartment of the floor panel 15 and an opening of the groove is opened to the inner surface 13 of the compartment. Here, in the accommodation groove 11, a direction intersecting at right angles to a longitudinal direction of the groove is set as a width of the groove.

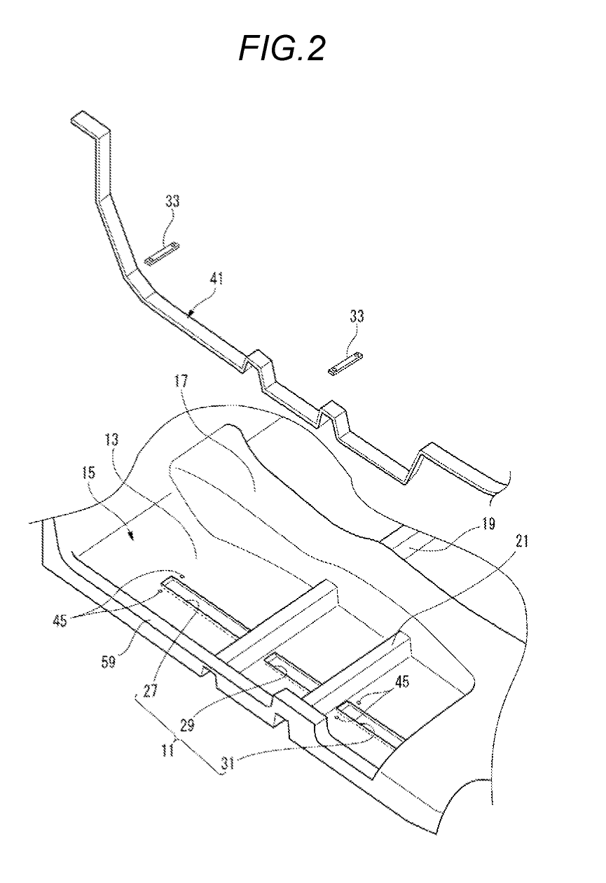

FIG. 2 is an exploded perspective view of main parts of the electric wire arrangement structure shown in FIG. 1.

In the first exemplary embodiment, the accommodation groove 11 is formed, as shown in FIG. 2, in the inner surface 13 of the compartment of the floor panel 15 in the left side from the center tunnel 17 in the direction of width of the vehicle. Further, the accommodation groove 11 is formed across the front cross member 19 or the rear cross member 21. Thus, the accommodation groove 11 is formed so as to be divided into a front accommodation groove 27, a central accommodation groove 29 and a rear accommodation groove 31. The electric wire accommodated in the front accommodation groove 27, the central accommodation groove 29 and the rear accommodation groove 31 crosses the front cross member 19 or the rear cross member 21 so that the electric wire is arranged forward and rearward of the vehicle. When a strength of the floor panel 15 can be ensured or easily molded (when the floor panel is made of a resin), the accommodation groove 11 maybe recessed in the inner surface 13 of the compartment (a protruding outer surface) of the front cross member 19 or the rear cross member 21. Namely, the accommodation recessed part of the present invention may be provided at least in the inner surface 13 of the compartment in a part to which a load stress by a crew or a baggage in the body panel may be possibly applied. However, the accommodation groove may be provided over an entire length in the extending direction of the electric wire in the inner surface of the compartment of the body panel in an inner space of the compartment.

The electric wire accommodated in the accommodation groove 11 is held by a below-described cross plate 33 as a holding member.

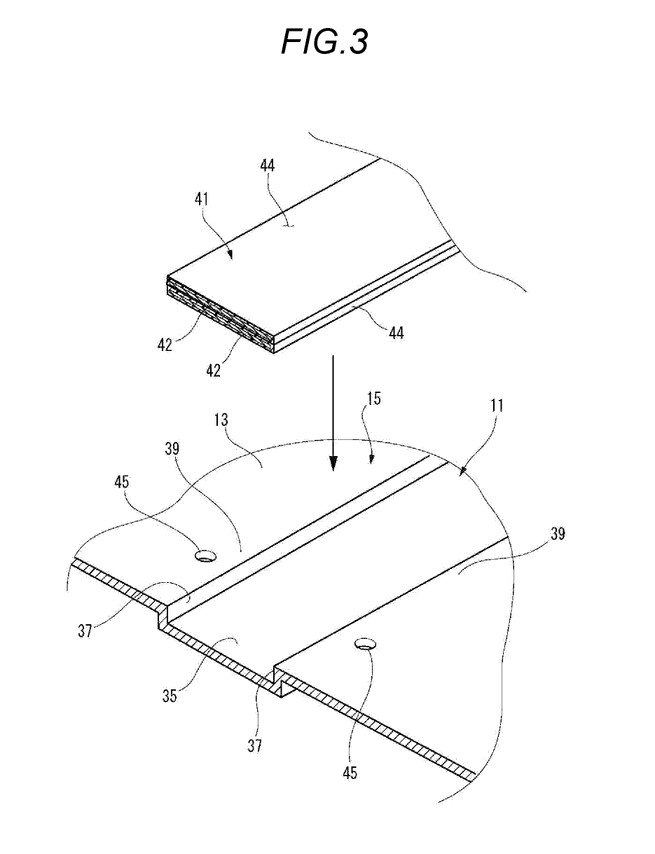

FIG. 3 is an enlarged sectional and perspective view of main parts which explains the electric wire arrangement structure shown in FIG. 1.

In the accommodation groove 11 of the first exemplary embodiment, a groove bottom 35 is straight in section intersecting at right angles to the longitudinal direction as shown in FIG. 3. The opening of the groove is parallel to the groove bottom 35. The accommodation groove 11 has a flat rectangular sectional form in which a depth of the groove is smaller than a width of the groove. In the groove bottom 35 of the accommodation groove 11, both ends in the direction of width of the groove are connected to lower ends of a pair of parallel groove side walls 37 in section intersecting at right angles to the longitudinal direction. Upper ends of the pair of parallel groove side walls 37 are connected to groove edges 39 of the opening of the groove (namely, the inner surface 13 of the compartment in the vicinity of the opening of the groove).

The electric wire which is at least partly accommodated in the accommodation groove 11 is formed with an arrangement material having at least one kind of conductors of, for instance, a flat shaped conductor, a round rod shaped conductor and a twisted wire. In the first exemplary embodiment, the electric wire is formed with an arrangement material 41 in which a plurality of (two in the present exemplary embodiment) of flat shaped conductors 42 covered with an insulating layer 44 are laminated. The arrangement material 41 is adopted hereinafter as a subordinate concept of the electric wire of the present invention.

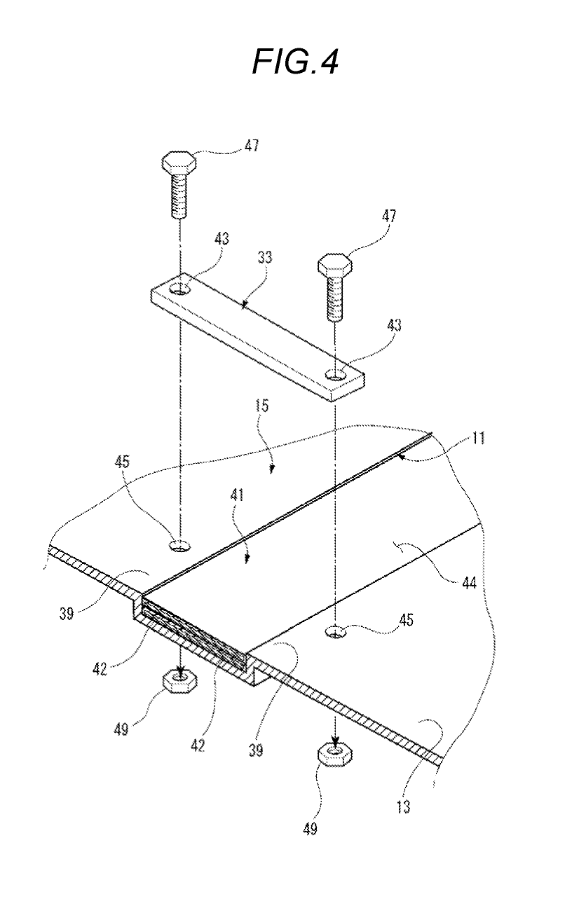

The arrangement material 41 is formed in such away that the two flat shaped conductors 42 which are electrically insulated are laminated in a direction of thickness. For instance, one flat shaped conductor 42 is used as a power supply wire (a 12V wire) and the other flat shaped conductor 42 is used as a ground wire (GND wire). In the first exemplary embodiment, the arrangement material 41 is formed so as to have the same sectional form as that of the accommodation groove 11. Accordingly, when the arrangement material 41 is accommodated in the accommodation groove 11, the right and left groove edges 39 which sandwich the accommodation groove 11 between them are continuous on substantially the same plane by an upper surface of the arrangement material 41 (see FIG. 4).

FIG. 4 is an enlarged sectional and perspective view of main parts that explains the holding member which accommodates and holds the arrangement material 41 (the electric wire) shown in FIG. 3 in the accommodation recessed part 11.

The holding member of the first exemplary embodiment is the cross plate 33 arranged so as to intersect the longitudinal direction of the accommodation groove 11. The cross plate 33 is formed in the shape of a rectangular flat plate which is long in the direction of groove width of the accommodation groove 11 and a pair of fixing holes 43 and 43 are bored at both ends in the longitudinal direction. In the floor panel 15, a plurality of pairs of bolt through holes 45 and 45 are bored in the groove edges 39 and 39 of the opening of the groove which sandwich the accommodation groove 11 between them. The cross plate 33 strides over the accommodation groove 11 in which the arrangement material 41 is accommodated, bolts 47 respectively passed through the one pair of fixing holes 43 and 43 are passed through the pair of bolt through holes 45 and 45 of the floor panel 15 and nuts 49 are respectively screwed to the passed through ends of the bolts. In such a way, the arrangement material 41 is held in the accommodation groove 11.

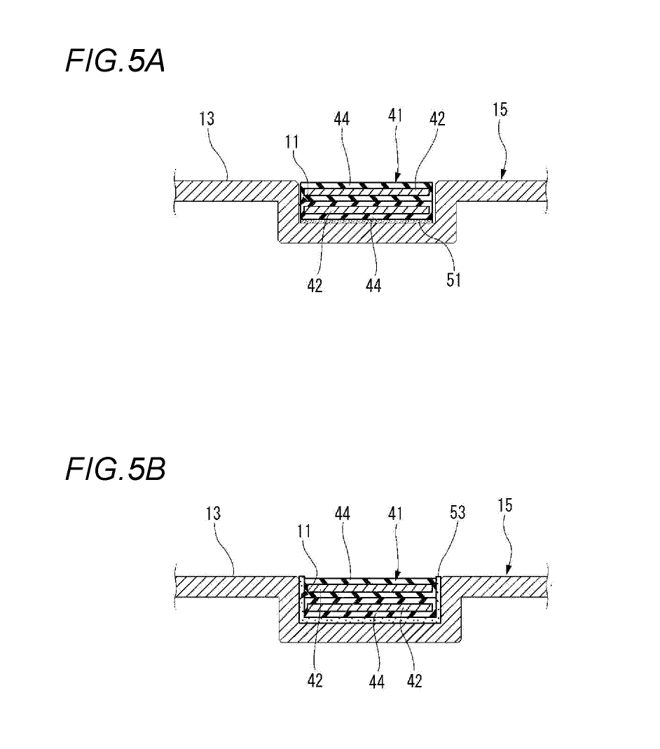

FIG. 5A is an enlarged sectional view of main parts that explains an electric wire arrangement structure according to a modified example in which an adhesive layer 51 is provided between an accommodation groove 11 and an arrangement material 41 (an electric wire). FIG. 5B is an enlarged sectional view of main parts that explains an electric wire arrangement structure according to a modified example in which an arrangement material 41 (an electric wire) is accommodated in an accommodation groove 11 through an impact absorbing member 53.

In the electric wire arrangement structure according to the first exemplary embodiment, the holding member is not limited to the above-described cross plate 33. As the holding member, for instance, the adhesive layer 51 may be used which is provided between the accommodation groove 11 and the arrangement material 41 as shown in FIG. 5A. The adhesive layer 51 may be used as, for instance, a double side viscous tape provided only in the groove bottom 35 of the accommodation groove 11. Additionally, the adhesive layer 51 may be formed by applying an adhesive agent to the groove bottom 35 of the accommodation groove 11 or a lower surface of the arrangement material 41.

Further, in the electric wire arrangement structure according to the modified example of the first exemplary embodiment, as shown in FIG. 5B, the arrangement material 41 maybe accommodated in the accommodation groove 11 through the impact absorbing member 53. As the impact absorbing member 53, a sheet material such as a foaming material or a non-woven fabric having a cushioning property can be used. In this case, in the sheet material, on a surface opposed to the arrangement material 41 or a surface opposed to the groove bottom 35 of the accommodation groove 11, the adhesive layer 51 may be provided. Further, the arrangement material 41 on the periphery of which a sheet shaped or a tape shaped impact absorbing member is wound may be accommodated in the accommodation groove 11.

Now, an operation of the above-described structure will be described below.

Before the operation of the electric wire arrangement structure according to the first exemplary embodiment is explained, an operation of an electric wire arrangement structure according to a reference example is explained.

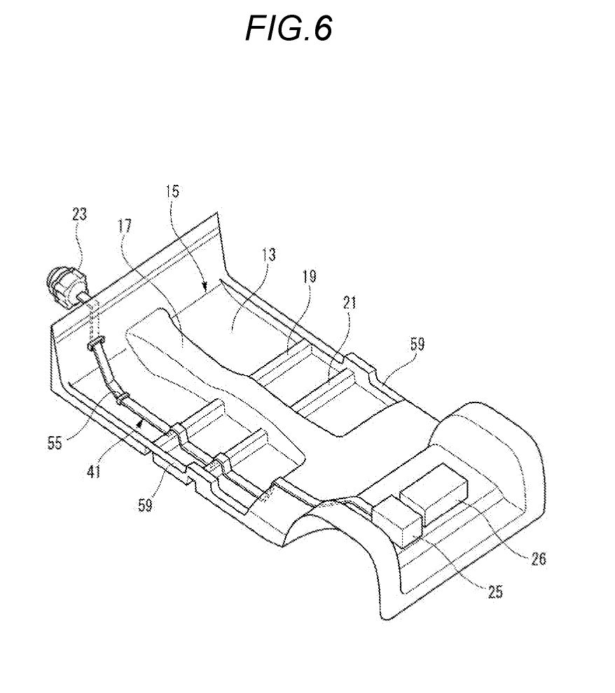

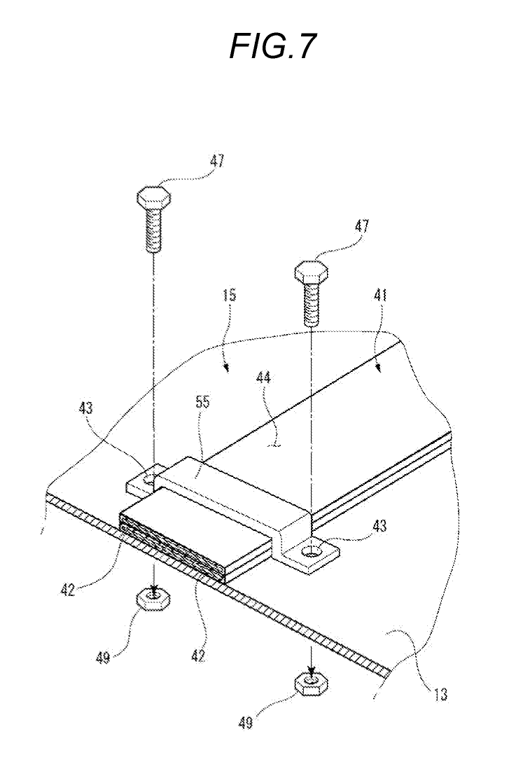

FIG. 6 is a perspective view showing an arrangement example in a vehicle having the electric wire arrangement structure according to the reference example. FIG. 7 is an enlarged sectional and perspective view of main parts that explains the electric wire arrangement structure shown in FIG. 6.

In the electric wire arrangement structure according to the reference example, as shown in FIG. 6, an arrangement material 41 is arranged forward and rearward of the vehicle along a floor panel 15. As shown in FIG. 7, the arrangement material 41 is arranged to protrude from an inner surface 13 of a compartment of the floor panel 15. The arrangement material 41 is held on the floor panel 15 by a tall clamp 55 which strides over an outer periphery of the arrangement material 41 in a direction of width.

In the electric wire arrangement structure according to the reference example, when the arrangement material 41 has many circuits, since a plurality of flat shaped conductors 42 are laminated, an arrangement space is necessary in a direction of height. Accordingly, a residence space in the compartment is oppressed. Further, in the electric wire arrangement structure according to the reference example, when the arrangement material 41 is arranged at one's feet, there is a fear that the electric wire may be possibly cut due to a stepping.

As compared therewith, in the electric wire arrangement structure according to the first exemplary embodiment, as shown in FIG. 4, the accommodation groove 11 is formed in the inner surface 13 of the compartment in the part to which the load stress by the crew or the baggage may be possibly applied in the body panel. In the accommodation groove 11, the opening of the groove is opened to the inner surface 13 of the compartment and the arrangement material 14 is accommodated. The arrangement material 41 is held in the accommodation groove by the cross plate 33. The arrangement material 41 accommodated in the accommodation groove 11 does not protrude outside the groove from the opening of the groove. Accordingly, an oppression of a residence space in the compartment due to a protrusion of the arrangement material 41 to the compartment side from the inner surface 13 of the compartment does not occur.

Further, since the accommodation groove 11 is formed in the floor panel 15 of a riding room as the body panel, a width of the groove is set to be smaller than a width of a foot of an ordinary man. Accordingly, a load stress due to a stepping operation is supported by the groove edges 39 at both sides which hold a width of the groove, so that the load stress is hardly concentrated on the arrangement material 41. Accordingly, the arrangement material 41 can be avoided from being cut. Thus, a protector for protecting the electric wire or an outer sheath for meeting the stepping operation can be reduced and a cost of a wire harness including the arrangement material 41 can be lowered.

Further, since the arrangement material 41 is formed so as to have a flat shape with a flat and rectangular section which is substantially the same as that of the accommodation groove 11, when the arrangement material 41 is accommodated in the accommodation groove 11, the right and left groove edges 39 which hold the accommodation groove 11 between them are continuous substantially on the same plane through an upper surface of the arrangement material 41. In the accommodation groove 11 in which the above-described flat shaped arrangement material 41 is accommodated, when the floor panel 15 is covered with a carpet or the like, a flat floor carpet surface having no irregularities can be obtained without using a protector. Thus, a deterioration of an attractive appearance or an uncomfortable feeling upon stepping can be eliminated.

Further, in the structure that the flat shaped arrangement material 41 is accommodated so as to be fitted to the accommodation groove 11 having substantially the same sectional form, a backlash or vibration of the arrangement material 41 can be suppressed. Thus, an occurrence of abnormal sound or an abrasion of the arrangement material 41 is suppressed, so that durability can be improved.

Further, in the electric wire arrangement structure according to the modified example of the first exemplary embodiment shown in FIG. 5A, since the holding member uses the adhesive layer 51, the long arrangement material 41 can be fixed to the accommodation groove 11 in a longitudinal direction (continuously) of the accommodation groove 11 and over a wide range of the accommodation groove 11.

Further, in the electric wire arrangement structure according to the modified example of the first exemplary embodiment shown in FIG. 5B, at least one part of the arrangement material 41 is accommodated in the accommodation groove 11 through the impact absorbing member 53. In this structure, to the accommodation material 41 accommodated in the accommodation groove 11, an impact directly applied to the arrangement material 41 from the opening of the groove, a stress due to the deformation of the floor panel 15 or an impact applied through the floor panel 15 from an outer surface of the compartment can be absorbed by the impact absorbing member 53. Further, since the impact absorbing member 53 occupies a space between the accommodation groove 11 and the arrangement material 41, a backlash of the arrangement material 41 or abnormal sound or an abrasion due to a vibration can be suppressed.

### Second Exemplary Embodiment

Now, an electric wire arrangement structure according to a second exemplary embodiment of the present invention will be described below.

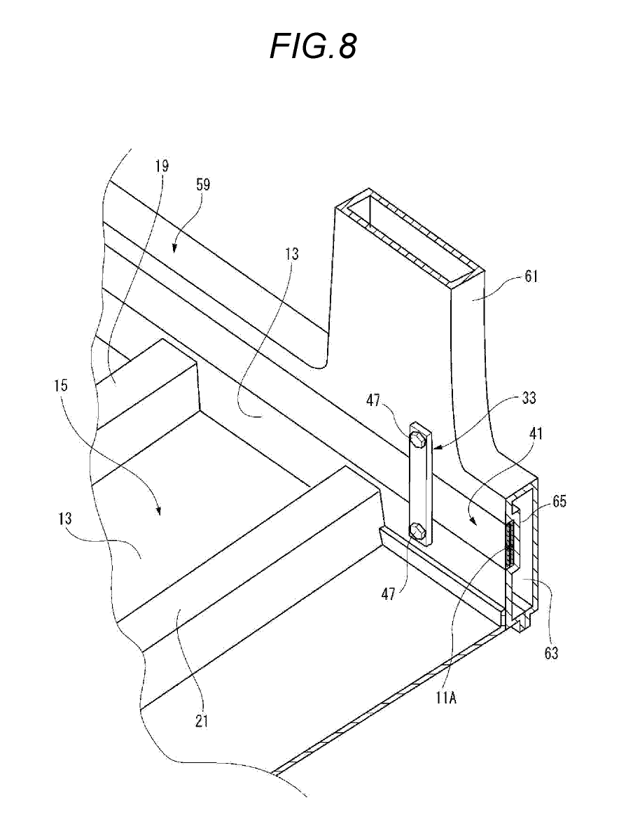

FIG. 8 is an enlarged sectional and perspective view of main parts showing an arrangement example in a vehicle which has an electric wire arrangement structure according to a second exemplary embodiment of the present invention. In the electric wire arrangement structure of the second exemplary embodiment, the same structure as that of the arrangement structure described in the first exemplary embodiment is designated by the same reference numeral and a duplicated explanation is omitted.

The electric wire arrangement structure according to the second exemplary embodiment is provided, as shown in FIG. 8, in a side sill 59 as a body panel. In the side sill 59, a center pillar 61 stands upright. An accommodation groove 11A of the second exemplary embodiment is an accommodation recessed part recessed in an inner surface 13 (an inner side surface) of a compartment of the side sills 59 provided in both right and left sides of a floor panel 15 along a forward and rearward direction of a vehicle. A swelling part 65 of the accommodation groove 11A which swells outside the compartment is accommodated in a frame space 63 of the side sill 59. Bolts 47 passing through the inner surface 13 of the compartment of the side sill 59 are screwed to welding nuts (not shown in the drawing) fixed to a back surface of the side sill 59 and fixed by a cross plate 33. Other structures are the same as those of the electric wire arrangement structure according to the above-described first exemplary embodiment.

According to the electric wire arrangement structure according to the second exemplary embodiment, since the accommodation groove 11A is formed in the side sill 59, the accommodation groove 11 is not provided in the floor panel 15. Thus, an arrangement material 41 can be arranged without oppressing a residence space in the compartment. Further, the swelling part 65 of the accommodation groove 11A can be hidden in the frame space 63.

### Third Exemplary Embodiment

Now, an electric wire arrangement structure according to a third exemplary embodiment of the present invention will be described below.

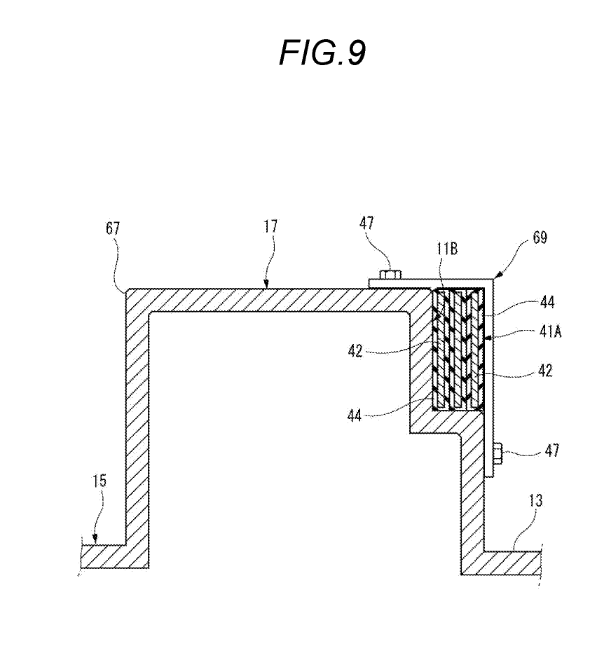

FIG. 9 is an enlarged sectional view of main parts which explains an electric wire arrangement structure according to a third exemplary embodiment of the present invention. In the electric wire arrangement structure of the third exemplary embodiment, the same structure as that of the arrangement structure described in the first exemplary embodiment is designated by the same reference numeral and a duplicated explanation is omitted.

In the electric wire arrangement structure according to the third exemplary embodiment, as shown in FIG. 9, an accommodation cut-out part 11B is provided in a shoulder part 67 of a center tunnel 17 in a floor panel 15 as a body panel.

An arrangement material 41A has three flat shaped conductors 42 laminated which are covered with an insulating layer 44 and is accommodated in the accommodation cut-out part 11B formed in the shoulder part 67 of the center tunnel 17 which rises continuously to an inner surface 13 of a compartment of the floor panel 15. In the center tunnel 17, a section intersecting at right angles to a longitudinal direction rises in a rectangular form. The accommodation cut-out part 11B is formed along an extending direction of the center tunnel 17 by cutting out either one of the right and left rectangular shoulder parts 67 in the shape of L in section. The arrangement material 41A accommodated in the accommodation cut-out part 11B as an accommodation recessed part cut out in the shape of L in section is held by an L shaped cross plate 69. Other structures are the same as those of the electric wire arrangement structure according to the first exemplary embodiment.

In the electric wire arrangement structure according to the third exemplary embodiment, since the accommodation cut-out part 11B as the accommodation recessed part is formed not only in the inner surface 13 of the compartment of the planar floor panel 15, but also in the center tunnel 17 as the rising part (a protruding part) of the inner surface 13 of the compartment, the arrangement material 41A can be arranged without oppressing a residence space in the compartment.

### Fourth Exemplary Embodiment

Now, an electric wire arrangement structure according to a fourth exemplary embodiment of the present invention will be described below.

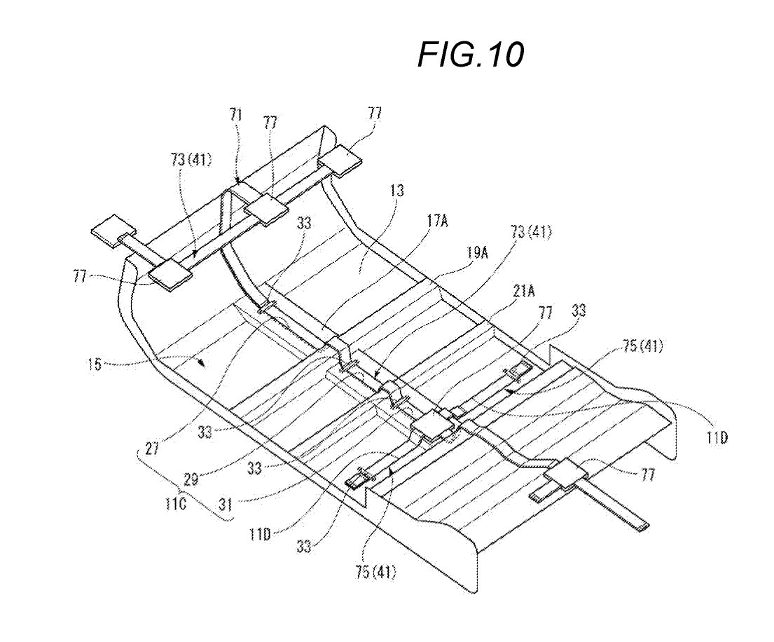

FIG. 10 is a perspective view showing an arrangement example of a circuit body 71 for a vehicle in the vehicle which has an electric wire arrangement structure according to the fourth exemplary embodiment of the present invention.

In the electric wire arrangement structure of the fourth exemplary embodiment, the same structure as that of the arrangement structure described in the first exemplary embodiment is designated by the same reference numeral and a duplicated explanation is omitted.

The circuit body 71 for the vehicle having the electric wire arrangement structure according to the fourth exemplary embodiment includes, as shown in FIG. 10, a main line 73 as an electric wire, a branch line 75 as an electric wire and control boxes 77 having control parts (an illustration is omitted).

In the circuit body 71 for the vehicle, the main line 73 and the branch line 75 are formed with an arrangement material having at least one kind of conductors of, for instance, a flat shaped conductor, a round rod shaped conductor and a twisted wire. In the present fourth exemplary embodiment, the main line 73 and the branch line 75 are formed with the arrangement material 41 in which a plurality of flat shaped conductors 42 covered with an insulating layer 44 are laminated.

The main line 73 is an electric wire which has a power supply line with a determined current capacity and is arranged in a vehicle body. The branch line 75 is an electric wire connected to various kinds of electrical equipment loads. In the fourth exemplary embodiment, the main line 73 and the branch line 75 are formed with the arrangement material 41. The control part distributes directly or through the branch line 75 an electric power of the power supply line supplied to the main line 73 to the electrical equipment loads connected to the main line 73. The plurality of control boxes 77 are dispersed and arranged along the main line 73. To the control box 77 connected to the main line 73, the branch line 75 is connected.

In the fourth exemplary embodiment, the main line 73 is formed in the shape of T in such a way that the main line 73 is accommodated in an accommodation groove 11C as an accommodation recessed part recessed mainly on an upper surface of a center tunnel 17A, strides over a front cross member 19A and a rear cross member 21A and is arranged forward and rearward of the vehicle, and is arranged along an inner panel. The accommodation groove 11C is formed so as to be divided into a front accommodation groove 27, a central accommodation groove 29 and a rear accommodation groove 31.

Further, the branch line 75 is accommodated and arranged in an accommodation groove 11D as an accommodation recessed part which strides over the center tunnel 17A and is formed rightward and leftward of a floor panel 15 of the vehicle. The branch line 75 is directly conducted and connected respectively to the electrical equipment loads by a connector or an arrangement material connection part. In this electric wire arrangement structure, the main line 73, the control boxes 77 and the branch line 75 are used, so that a power can be supplied to the electrical equipment loads of respective parts of the vehicle from a battery.

In the circuit body 71 for the vehicle according to the fourth exemplary embodiment, the whole part of the circuit body is used as a transmission path which is required to supply an electric power of a main power source such as a battery respectively to the various kinds of electrical equipment loads of parts of a vehicle body and transmit and receive signals between the electrical equipment loads.

The circuit body 71 for the vehicle can form a circuit of a simple structure with the main line 73 having a determined current capacity and a determined communication capacity and arranged in the vehicle body and the branch line 75 which connects the various kinds of electrical equipment loads to the main line 73 through the plurality of control boxes 77 dispersed and arranged along the main line 73.

Then, the electric wires (the arrangement materials 41) forming the main line 73 and the branch line 75 of the circuit body 71 for the vehicle is accommodated in the accommodation grooves 11C and 11D provided in an inner surface 13 of a compartment of the floor panel 15 and accommodated and held in the accommodation grooves 11C and 11D by cross plates 33. Thus, in the circuit body 71 for the vehicle, an oppression of a residence space in the compartment due to a protrusion of the main line 73 and the branch line 75 to the compartment side from the inner surface 13 of the compartment does not occur.

As the various kinds of electrical equipment loads are installed, the circuit body 71 for the vehicle needs to be arranged throughout a wide range of the inner surface 13 of the compartment. In the circuit body 71 for the vehicle, since at least one part of the main line 73 or the branch line 75 arranged over the wide range is accommodated in the accommodation grooves 11C and 11D, the oppression to the residence space in the compartment can be more extremely suppressed than that in the usual structure in which the main line 73 and the branch line 75 protrude to the compartment side.

Further, in the circuit body 71 for the vehicle according to the fourth exemplary embodiment, since the main line 73 and the branch line 75 are formed with the arrangement material (in the fourth exemplary embodiment, the arrangement material 41 having the flat shaped conductors 42) having at least one kind of conductors of the flat shaped conductor, the round rod shaped conductor and the twisted wire, an electric wire formed with the arrangement material having the conductor suitable for an arrangement path of the vehicle can be used for each main line 73 between the plurality of control boxes 77. Thus, an arrangement property is improved.

### Fifth Exemplary Embodiment

Now, an electric wire arrangement structure according to a fifth exemplary embodiment of the present invention will be described below.

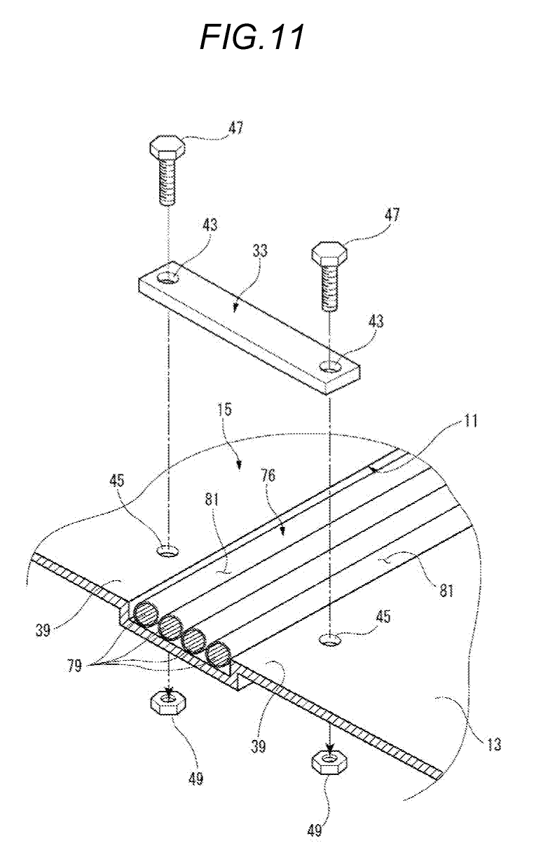

FIG. 11 is an enlarged sectional and perspective view of main parts which explains an electric wire arrangement structure according to a fifth exemplary embodiment of the present invention. In the electric wire arrangement structure of the fifth exemplary embodiment, the same structure as that of the arrangement structure described in the first exemplary embodiment is designated by the same reference numeral and a duplicated explanation is omitted.

In the electric wire arrangement structure according to the fifth exemplary embodiment, as shown in FIG. 11, an electric wire is formed in such a way that a plurality of arrangement materials 76 having round rod conductors 79 insulated and coated with an insulating layer 44 are arranged in parallel on the same plane. Other structures are the same as those of the first exemplary embodiment.

According to the electric wire arrangement structure of the fifth exemplary embodiment, since the round rod conductors 79 which are easily available are used, the arrangement material 76 can be inexpensively formed.

According to the electric wire arrangement structures of the exemplary embodiments, the oppression of the residence space in the compartment by the electric wire and the damage of the electric wire can be prevented at the same time.

Further, in the circuit body 71 for the vehicle of the above-described exemplary embodiment, the residence space in the compartment is not oppressed and the main line 73 and the branch line 75 can be accommodated in the accommodation groove 11C and an accommodation groove 11D provided in the inner surface 13 of the compartment under a protected state.

The present invention is not limited to the above-described exemplary embodiments and it is to be understood in the present invention and included within a scope to be protected that the structures of the exemplary embodiments are respectively combined together and a person with ordinary skill in the art makes a change or an application in accordance with the description of the specification and a well-known technique.

Here, features of the above-described exemplary embodiments of the electric wire arrangement structure and the circuit body for a vehicle according to the present invention are briefly summarized and listed in the following [1] to [7].
[1] An electric wire arrangement structure comprising: an accommodation recessed part (an accommodation groove 11, 11A, an accommodation cut-out part 11B) disposed in an inner surface (13) of a compartment of a body panel (a floor panel 15, a side sill 59, a center tunnel 17);

an electric wire (an arrangement material 41) which is at least partly accommodated in the accommodation recessed part (the accommodation groove 11, 11A, the accommodation cut-out part 11B), and

a holding member (a cross member 33) which accommodates and holds at least apart of the electric wire in the accommodation recessed part.
[2] The electric wire arrangement structure according to the above-described [1],

wherein the holding member is a cross plate (33, 69) which is constructed to intersect a longitudinal direction of the accommodation recessed part (the accommodation groove 11, 11A, the accommodation cut-out part 11B).
[3] The electric wire arrangement structure according to the above-described [1],

wherein the holding member is an adhesive layer (51) disposed between the accommodation recessed part (the accommodation groove 11) and the electric wire (the arrangement material 41).
[4] The electric wire arrangement structure according to the above-described [1] or [2],

wherein the electric wire (the arrangement material 41) is accommodated in the accommodation recessed part (the accommodation groove 11) in a state that an impact absorbing member (53) is disposed between the electric wire and the accommodation recessed part.
[5] The electric wire arrangement structure according to any one of the above-described [1] to [4],

wherein the accommodation recessed part (the accommodation cut-out part 11B) is disposed in a shoulder part (67) of the center tunnel (17) in the body panel (the floor panel 15).
[6] A circuit body (71) for a vehicle comprising:

a main line (73) having a power supply line with a determined current capacity and arranged in a vehicle body;

a branch line (75) connected to an electrical equipment load; and

a control box (77) which has a control part distributing an electric power which is supplied from the power supply line to the main line, to the branch line connected to the main line, and which is arranged on the main line,

wherein at least one of the main line and the branch line is formed with an electric wire (an arrangement material 41) which is at least partly accommodated in an accommodation recessed part (an accommodation groove 11C, an accommodation groove 11D) disposed in an inner surface (13) of a compartment of a body panel (a floor panel 15), and

wherein at least apart of the electric wire is accommodated and held in the accommodation recessed part (the accommodation groove 11C, the accommodation groove 11D) by a holding member (a cross member 33).
[7] The circuit body for the vehicle according to the above-described [6],

wherein the electric wire is formed with an arrangement material (41) having at least one kind of conductors of a flat shaped conductor (42), a round rod conductor, and a twisted wire.

### DESCRIPTION OF REFERENCE NUMERALS AND SIGNS

11 . . . accommodation groove (accommodation recessed part)
13 . . . inner surface of compartment
15 . . . floor panel (body panel)
17 . . . center tunnel
33 . . . cross plate (holding member)
41 . . . arrangement material (electric wire)

What is claimed is:

1. An electric wire arrangement structure comprising:
an accommodation recessed part disposed in an inner surface of a compartment of a body panel;
an electric wire which is at least partly accommodated in the accommodation recessed part, and
a holding member which accommodates and holds at least a part of the electric wire in the accommodation recessed part.

2. The electric wire arrangement structure according to claim 1,
wherein the holding member is a cross plate which is constructed to intersect a longitudinal direction of the accommodation recessed part.

3. The electric wire arrangement structure according to claim 1,
wherein the holding member is an adhesive layer disposed between the accommodation recessed part and the electric wire.

4. The electric wire arrangement structure according to claim 1,
wherein the electric wire is accommodated in the accommodation recessed part in a state that an impact absorbing member is disposed between the electric wire and the accommodation recessed part.

5. The electric wire arrangement structure according to claim 1,
wherein the accommodation recessed part is disposed in a shoulder part of the center tunnel in the body panel.

6. A circuit body for a vehicle comprising:
a main line having a power supply line with a determined current capacity and arranged in a vehicle body;
a branch line connected to an electrical equipment load; and
a control box which has a control part distributing an electric power which is supplied from the power supply line to the main line, to the branch line connected to the main line, and which is arranged on the main line,
wherein at least one of the main line and the branch line is formed with an electric wire which is at least partly accommodated in an accommodation recessed part disposed in an inner surface of a compartment of a body panel, and
wherein at least apart of the electric wire is accommodated and held in the accommodation recessed part by a holding member.

7. The circuit body for the vehicle according to claim 6,
wherein the electric wire is formed with an arrangement material having at least one kind of conductors of a flat shaped conductor, a round rod conductor, and a twisted wire.
